(19) United States
(12) Patent Application Publication
(10) Pub. No.: US 2004/0010422 A1
(43) Pub. Date: Jan. 15, 2004

(54) Method and apparatus for batch-processed invoicing

(76) Inventors: Cliff Michalski, Madison, WI (US); Ryan Niemeyer, Madison, WI (US); Satyajit Puniani, San Marcos, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/441,583

(22) Filed: May 20, 2003

Related U.S. Application Data
(60) Provisional application No. 60/381,866, filed on May 20, 2002.

(51) Int. Cl. G06F 17/60; G06F 7/00

(52) U.S. Cl. 705/2; 707/104.1

(57) ABSTRACT

A system and method for multi-staged management of batch processed invoicing assigns a status to discrete units in these batches and uses such status of the discrete units in these batches to perform a number of operations on the batch. Thus, processing a first batch of records having a first number of records comprises performing a first operation on a first portion of the first batch, assigning a first status to the first portion of the first batch, creating a second batch containing the first portion of the first batch with a first status, returning a first portion of the second batch to the first batch, performing a second operation on a second portion of the second batch, assigning a second status to the second portion of the second batch, creating a third batch containing the second portion of the second batch with the second status, and returning a first portion of the third batch to the second batch.

### CROSS-REFERENCE TO RELATED APPLICATIONS

This application claims priority to U.S. Provisional Application Serial No. 60/381,866, entitled, “A System and Method for Multi-staged Management of Batch-Processed Invoicing Based on Status of Discrete Units,” filed May 20, 2002, the disclosure of which is hereby expressly incorporated herein by reference.

### TECHNICAL FIELD

The present patent relates generally to a computerized system of batch processing invoices within a billing cycle; and more particularly, to a flexible method and system for the creation and processing of invoices especially as it relates to the healthcare and health insurance industries. The present patent is heretofore described in this context, although it is equally applicable to any industry that uses batch processing for the purpose of billing multiple customers at one time.

### BACKGROUND

The need to bill customers for healthcare and related services presents a challenging and complicated process to the healthcare and health insurance industries. Customers are billed on a periodic basis. A customer can alternately be defined as an individual or a group of individuals that purchases coverage together, such as an employer who purchases health coverage for his or her employees. Further, customers can be grouped together under the auspices of a single entity that handles the payment of multiple customers. Finally, these payment entities and other customers that do not have such an arrangement are grouped into billing cycles. A billing cycle is a predetermined interval at which invoices are generated for customers.

Theoretically, batch processing allows an organization to generate invoices for multiple customers sharing similar profiles at one time, thus increasing efficiency. It does, however, create several problems that could hinder the computerized billing system and the user or users working with the system.

A system or a user managing a complicated batch, such as occurs in the healthcare and health insurance industries as detailed above, is bound to find errors and inconsistencies during the course of processing. If we use an example from the health insurance agency, from month to month new employees enroll in and terminate coverage through an employer. This causes variances in the billed amount from one month to the next. If the invoice amounts for a given employer vary drastically from one month to the next, a user may have to research the variance to ensure that it was due to an enrollment change and not due to error. Many inconsistencies are possible given the complexity of the system. Current systems force a user to hold up the entire batch as he or she researches the problem. This is problematic for several reasons. A typical batch for a medium-sized to large-sized organization could include 800-1000 customers. If an error occurs for one customer in this batch, other systems might prevent the user from sending out timely invoices to the other customers in the batch. This would mean holding up several hundred invoices that would otherwise have gone out on time. Such delays increase the amount of time that an organization must wait for payment of services. It also typically forces the user to manually keep track of the customer or customers that require additional research and those that are ready to be processed. This is no small task with hundreds of customers in a single batch and can lead to mistakes and inefficiencies.

Additionally, if a mistake is found after processing of the batch has begun, the entire batch is typically affected. For example, if an error is noticed on a single invoice in the batch, a user may be forced to rerun the entire invoicing process for all of the customers in the batch. Compared to such systems, a system that allows a user to recalculate and regenerate the invoice for the problematic customer only will be much more efficient.

The limitations of current systems for batch processing, as detailed above, cause organizations to achieve a lower productivity rate than they would have with a more flexible system. Such inefficient systems as currently exist can cause organizations to seek out additional employees to handle the burden of unnecessary manual processes. They may also cause an organization to lose money, if it must wait to bill customers with accounts that are in order while an employee researches accounts that are not.

An additional problem that companies using batch processing of invoices face concerns the physical paper invoices. Since there is physical output at the end of the process, the process must have the ability to deal with equipment failure during the printing process, to regenerate lost paper invoices and to store a record of the invoice for future reference.

Existing billing cycle batch processing solutions acknowledge the complexities of batches that they are attempting to manage, but as of yet they have not found an acceptable answer to the problems listed above.

When dealing with a problem in a batch that must be researched, previous solutions have dealt with the problem in several ways:

One approach to deal with this problem is to hold the entire batch. In this solution, the entire batch waits for processing while a user researches the problem customer. As mentioned above, this requires the user to keep track of the customers that have processed correctly and those that have not processed correctly. This is unreliable and a strain on employees' workload. Further, it strains a company's resources, as the company cannot bill anyone in the batch until the problem is solved. Ideally, the company should be able to bill those customers that did not present immediate problems and send invoices for problem customers as each issue is resolved.

Another approach to deal with this problem is to remove problem customers from the batch. In this solution, the organization removes a customer that frequently has discrepancies from the general billing cycle batch. The organization then creates an ad hoc cycle to handle that customer. This solution creates several new problems, while only half solving the original problem. It means that the user must keep track of additional batches. This not only may increase the chance that mistakes will be made as the user struggles to manage progressively more batches, but also increases the amount of time that the user must spend processing batches, as he or she has multiple batches to process where there should be only one. It can also increase the amount of system resources that must be devoted to processing invoices. At the same time, this system works only for those customers that present frequent discrepancies. Unexpected discrepancies with customers that generally do not present discrepancies presumably will still force the user to hold the general billing cycle batch while he or she researches the problem.

Yet another approach to deal with this problem is to break down the cycle into smaller steps that can be stopped, reprocessed. This solution breaks the cycle down into a few steps, for example generation of the invoice and printing. When an error or inconsistency is encountered, a user can stop the process that is currently running, fix the problem, then rerun the process for the entire batch. In this solution, invoices that did not have any errors must be rerun along with those that did have errors. This is a drain on the system, and once again creates more manual work for the user. Additionally, the entire batch must be halted while the problem is solved.

### BRIEF DESCRIPTION OF THE DRAWINGS

The present patent is illustrated by way of example and not limitation in the accompanying figures, in which like references indicate similar elements, and in which:

FIG. 1 illustrates a block diagram of an overview of an embodiment of a system interface;

FIG. 2 illustrates a block diagram an exemplary implementation of a billing cycle;

FIG. 3 illustrates a block diagram of an exemplary implementation of various components of a batch;

FIG. 4 illustrates a flow chart of an exemplary implementation of sub-processes used for batch processing;

FIG. 5 illustrates a flow chart of an exemplary implementation of a sub-process used for computation of invoices;

FIG. 6 illustrates a flow chart of an exemplary implementation of a sub-process used for proofing of invoices;

FIG. 7 illustrates a flow chart of an exemplary implementation of a sub-process used for posting of invoices;

FIG. 8 illustrates a flow chart of an exemplary implementation of a sub-process used for creation of invoices;

FIG. 9 illustrates a flow chart of an exemplary implementation of a sub-process used for printing of invoices;

FIG. 10 illustrates a flow chart of an exemplary implementation of a sub-process used for automatic cancellation during retro-processing of batches;

FIG. 11 illustrates a flow chart of an exemplary implementation of a method for computation of an invoice;

FIG. 12 illustrates a flow chart of an exemplary implementation of backward movement of batches through various stages;

FIG. 13 illustrates a data network including a first group of healthcare facilities adapted to implement the system for batch processing invoices within a billing cycle;

FIG. 14 illustrates a schematic diagram of one embodiment of the network computer used in the data network; and

FIG. 15 illustrates a schematic diagram of one possible embodiment of several components located in one or more healthcare facilities.

### DETAILED DESCRIPTION OF THE DRAWINGS

A system and method for multi-staged management of batch processed invoicing assigns a status to discrete units in these batches and uses such status of the discrete units in these batches to perform a number of operations on the batch. Thus, processing a first batch of records having a first number of records comprises performing a first operation on a first portion of the first batch, assigning a first status to the first portion of the first batch, creating a second batch containing the first portion of the first batch with a first status, returning a first portion of the second batch to the first batch, performing a second operation on a second portion of the second batch, assigning a second status to the second portion of the second batch, creating a third batch containing the second portion of the second batch with the second status, and returning a first portion of the third batch to the second batch.

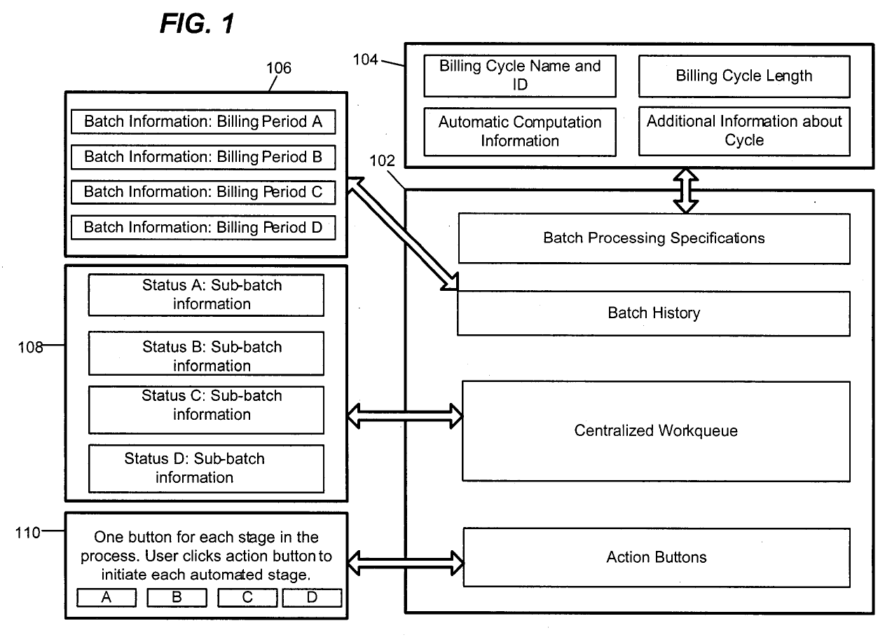

FIG. 1 illustrates a block diagram of an exemplary implementation of a system interface. The exemplary interface of FIG. 1 provides some of the information that a user of a billing system will need to process a batch in a single location. Various components of this interface are described in more detail below.

Block 102 of FIG. 1 illustrates one example of how an interface of the billing system may appear to a user. According to this example, a user screen is divided into four basic regions, containing, (1) specifications for a batch process, (2) a history of batch processing for the current and previous billing periods, (3) a work queue showing discrete units of a batch, and (4) a list of buttons that allows a user to prompt the system to begin a specific stage of processing. However, in an alternate implementation of the user interface an alternate number and configuration of interface blocks may be provided.

Block 104 of FIG. 1 illustrates one example of how a user may see information about specifications of a particular batch. According to this example, such information may include a name and/or and identification for identifying a cycle, a name of a user responsible for this cycle, information about when this cycle will compute automatically when such a system is set up for automatic batch processing, information about length of billing period for this cycle, information about invoice due date to be used for this cycle, etc. However, in an alternate implementation of the user interface other information about a particular batch may be provided.

Block 106 of FIG. 1 illustrates one example of how a user may see information about a history of a batch. According to this example, block 106 allows a user to see information about previous billing periods for a batch. This allows a user to quickly and easily determine average number of discrete units included in a single period for a batch, average monthly billable total for a batch, etc. According to one example, the discrete units represent customers or accounts. As processing of a batch progresses, such information makes it easy to see, without any manual processing, whether it is likely that a batch contained an error for the current billing period. In this example, all of the information needed to make such a determination is accessible from the interface described in FIG. 1.

For example, if a typical batch handled 50 customers (discrete units) each month, with a total billable amount of around $22,000 for previous billing periods, as displayed on block 106 of the user interface, but a given current billing period contained 30 customers with a total billable of $18,000, a user may be instantly alerted that the given batch may contain an error. In this case a user can view information about any billing period for a given batch by selecting that billing period from the batch history displayed in block 106, while he or she continues processing on a billing period that is not yet completed. Information about sub-batches and its discrete units for the batch selected in block 106 may appear in centralized work queues of block 108 as described below.

Block 108 of FIG. 1 illustrates one example of how a user may see information about a centralized work queue of a batch selected in block 106. In this example, the centralized work queue holds information about the status of the selected batch as well as information about all of its discrete units for a given billing period. As the selected batch or one of its discrete units progresses through various stages of the billing process, its name, and corresponding stage in the billing process and its status appears in the centralized work queue of block 108. In one example of the system interface described in FIG. 1, information about number of discrete units in a given batch that has reached a given stage in billing process also appears in block 108.

For example, in a batch of 800 customers, where a single customer is not ready for processing, that customer may remain in a Status A sub-batch, while the remaining 799 customers may progress normally through Statuses B and C, and finally end up in the Status D sub-batch. In this case, when a user looks at a centralized work queue for the billing cycle in question, he or she may see 799 customers in Status D sub-batch and one customer in Status A sub-batch. At this point the user may correct any errors for the one customer in Status A sub-batch, and re-run the Status B, C and D processes. In this example, finally, the user will see 800 customers in the Status D sub-batch on the centralized work queue.

In one example, by selecting a sub-batch in block 108 of the user interface a user may select sub-batches for which he or she wants to run next stage of billing process. In alternate example, a user may be allowed to select more than one sub-batch in block 108.

The work queue 108 of the exemplary implementation provides a centralized method of tracking pieces of a batch. Such a method of tracking pieces of a batch prevents the need to manually track progress of various batches through the billing process. Such a tracking method also allows a user to view some or all sub-batches within a process at once, regardless of their stage in the process.

An exemplary use of work queue to track pieces of various batches through billing process could be in a situation where a majority of batches are processed to completion, and invoices are printed for all of the customers in these batches, with the exception of, say, Customer A. Using the centralized work queue 108 of the exemplary implementation, a user may see at a glance which customers are processed and which are not. In such a situation a user may, for example, access additional information about the stage of billing process for Customer A, and if necessary the user may initiate the next step in the billing process for Customer A by selecting the sub-batch containing Customer A in block 108.

Block 110 of FIG. 1 illustrates one example of how a user may initiate one of a number of processes for a sub-batch selected on a centralized queue in block 108. By clicking a button, a user may initiate a stage in the billing process for one or more sub-batches selected on the centralized work queue 108. The exemplary implementation of the user interface given in FIG. 1 illustrates four such buttons, each corresponding to one different action in a billing process, for example, one button for proofing a sub-batch, one button for posting a sub-batch, etc. However, alternate examples of user interface may have more or less number of buttons for selecting various actions in a billing process. Alternate examples of the user interface may also provide one or more buttons that can be used to select more than one action in the billing process.

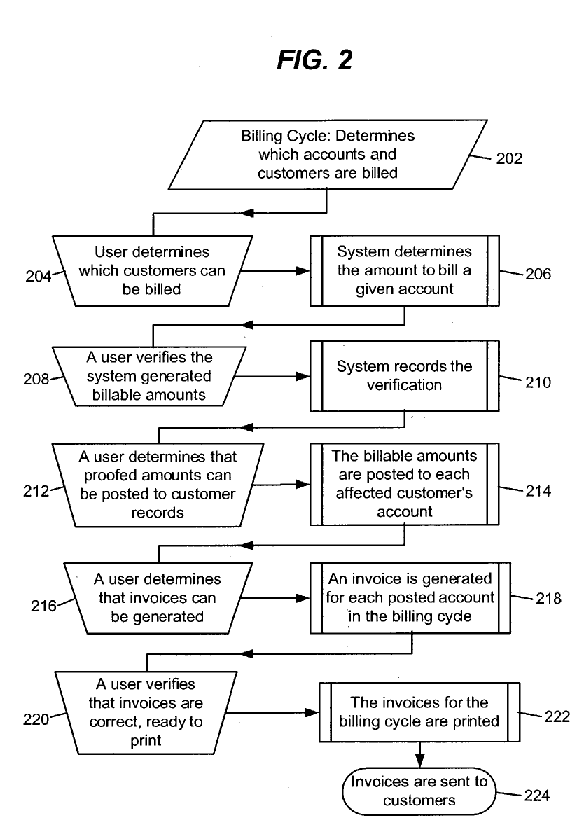

FIG. 2 illustrates a block diagram of an exemplary implementation of a billing cycle. According to this example, a billing cycle is sub-divided into more than one distinct stages. As one or more sub-batch progresses through these stages, a status is associated to these sub-batches that allows tracking the progress of the sub-batch.

Block 202 of FIG. 2 illustrates an initial stage of processing. An entire batch or a sub-batch may result in the initial stage of processing by being presented to the billing process for the first time or by having been backed to the initial stage from one or more of the later stages. According to the illustrated example, a batch in the initial stage of processing is given a status of “New.”

Block 204 of FIG. 2 can be implemented either as an automatic process or a manual process. If a user selects this stage to be a manual process the user will have to command the system to process a batch in the initial stage with status of “New.”Alternatively, in an implementation where block 204 is selected to be automatic, the system may automatically begin to process a batch in the initial stage with status of “New.”

In one example, a computation stage is implemented separate from the actual generation of the invoice, to provide large multiple-location organizations the flexibility to complete these stages at different locations, if they so desire. Implementation in separate stages also minimizes the amount of the process that may have to be repeated if an error is discovered during either the computation or the invoicing stage. According to one example, block 206 of FIG. 2 represents the computing stage of a billing process. If a user in block 204 prompts the system to activate block 206, block 206 computes the invoice amount for various components of one or more batches presented to block 206 with the status of “New.” At this stage, the computed amounts are not yet posted to the customers' accounts, and a physical invoice is not yet created. Batches and customers that have completed this stage receives a status of “Computed.”

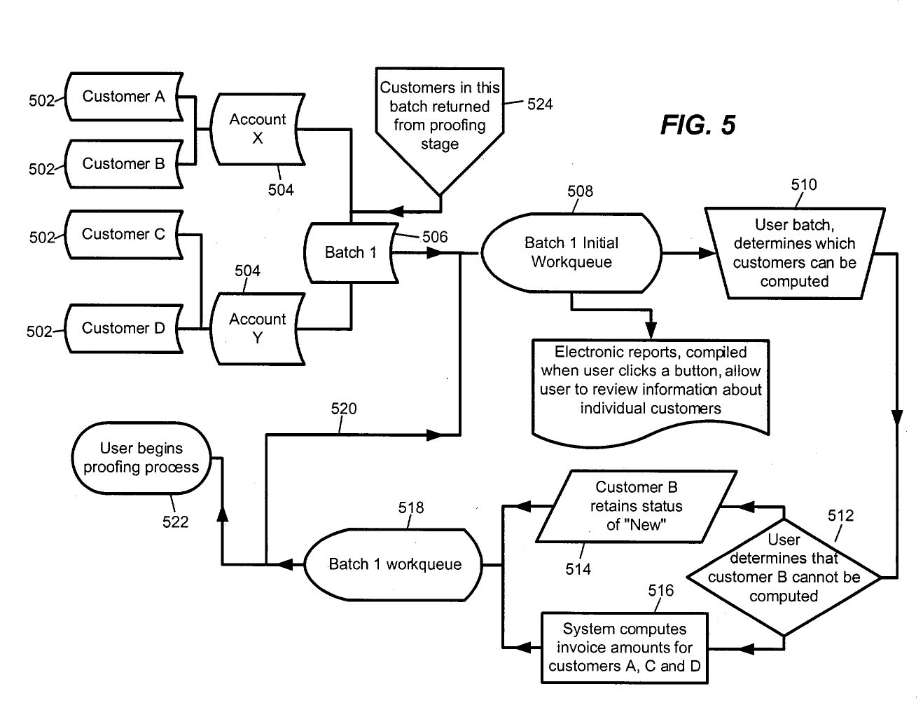

Block 208 of FIG. 2 illustrates a stage that allows a user to check the computed amounts for accuracy. In addition to information about the computation on the batch display, electronic reports, to be described hereinafter in FIG. 5, allows a user to quickly and easily scan details of the current and previous billing periods to determine whether any discrepancies have occurred. At block 208, a user is able to select and deselect individual customers for inclusion in the next process, which as described below is the proofing process. Those customers that appear to have discrepancies can be deselected and held for further research, and can be proofed at any time.

Once a user scans the repotted information and finds no discrepancies, at block 210 of FIG. 2, the user can prompt the system to record that the computed information has been verified. In an example, this stage illustrated by block 210 or FIG. 2 is called the proofing process. At block 210 of FIG. 2, each of the verified customers receives a status of “Proofed.”

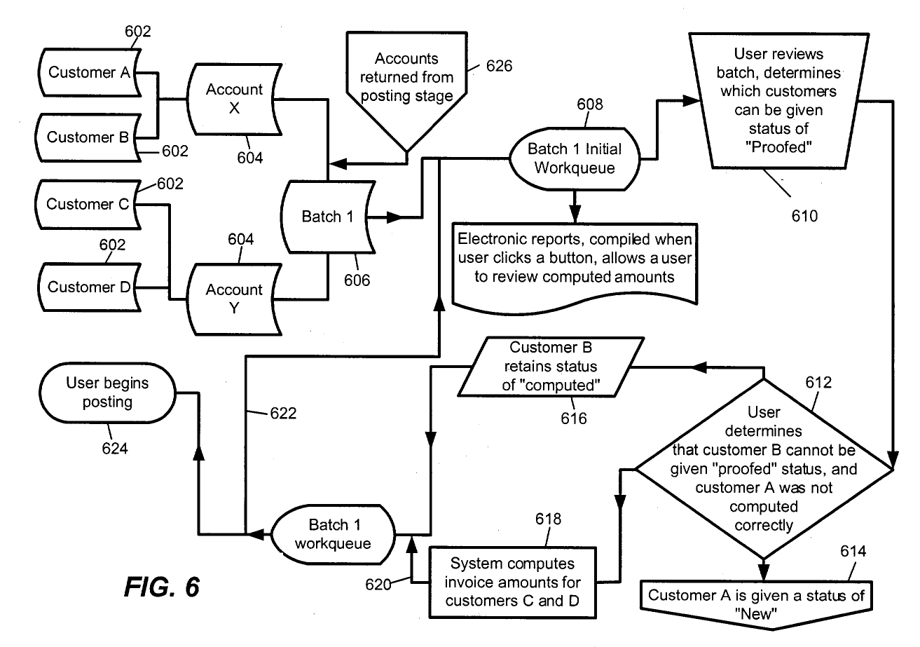

Block 212 of FIG. 2 illustrates the posting stage of the illustrated billing process. This stage allows a user to prompt the system to post the “Proofed” amounts to customers' accounts. At this stage of the billing process, a user has the ability to select and deselect accounts to which the system will post the computed amounts. As illustrated hereinafter in FIG. 6, electronic reports available directly from the interface 102 helps a user to select or deselect accounts to which the system will post the computed amounts.

At block 214 of FIG. 2, those accounts that were selected in block 212 of FIG. 2 are posted. The accounts which were not selected to be posted remains in the sub-batch in which they were before the posting process began. At this stage, those accounts for which at least one customer has been posted receives a status of “Posted.”

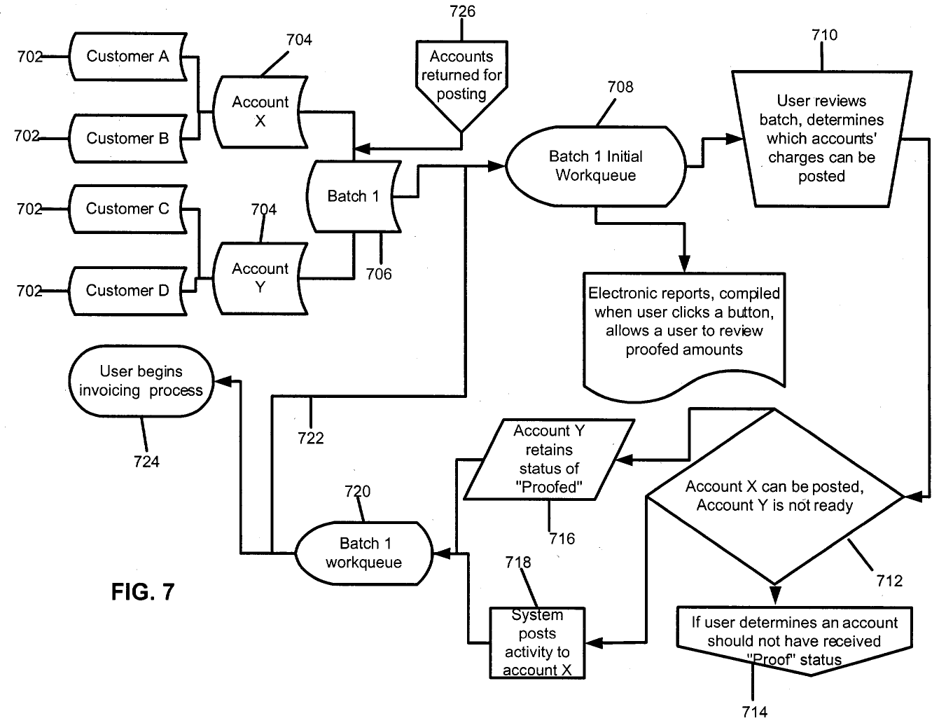

Block 216 of FIG. 2 illustrates the invoicing stage of the billing process. This stage allows a user to review the posted amounts, and prompt the system to generate invoices for the selected accounts. At this stage, accounts can be deselected if a user determines that the invoice for a particular account should not yet be created. Electronic reports, to be illustrated hereinafter in FIG. 7, available directly from the interface 102 helps a user to select or deselect accounts for which the system will generate an invoice.

Once a user initiates invoice generation, at block 218 of FIG. 2, the system creates an electronic version of each invoice. The electronic version of the invoice is stored in the system for later printing. Customers for the accounts for which an electronic invoice is generated receives the status of “Invoiced.”

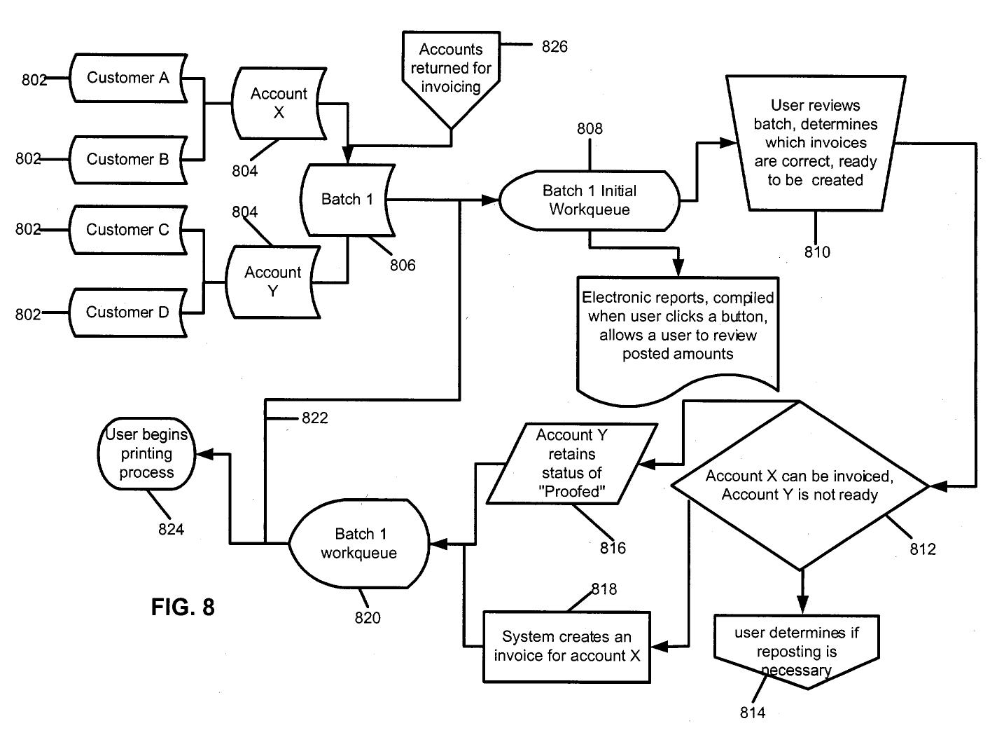

Block 220 of FIG. 2 illustrates the printing stage of the billing cycle. This stage of the billing cycle allows a user to prompt the system to create a printed copy of an invoice. The user can select or deselect accounts for inclusion in the print run. Only those customers and accounts that have received the status of “Invoiced” can be selected for printing. Electronic reports, to be illustrated hereinafter in FIG. 8, available directly from the interface 102 helps a user to select or deselect accounts for which the system will print an invoice.

Once a user prompts the system to initiate invoice printing, at block 222 of FIG. 2, the system prints invoices selected for printing. Printed invoices generated in the printing stage are sent to customers at stage 224 of FIG. 2.

While the exemplary implementation described in FIG. 2 enumerates various stages of billing process listed above, alternate implementation of the billing process may contain more or less number of stages. Alternatively, the order of these stages may also be different, for example, in one implementation of the billing process, there may be an additional proofing stage after the posting stage.

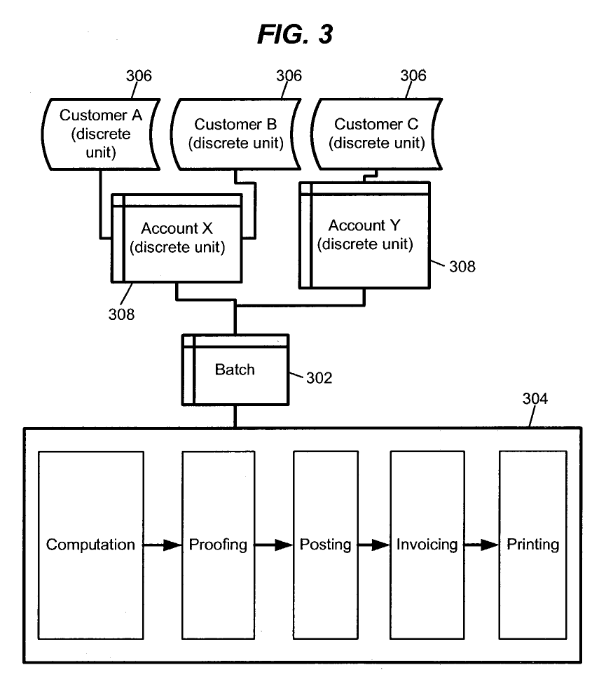

FIG. 3 illustrates a block diagram of an exemplary implementation of various components of a batch. According to this implementation, the batch 302 can be divided in two different ways into various subdivisions. According to one implementation, batch 302 is divided into individual discrete units or individual customers that make up the batch. Each of these sub-divisions may be used to create a flexible system for batch processing.

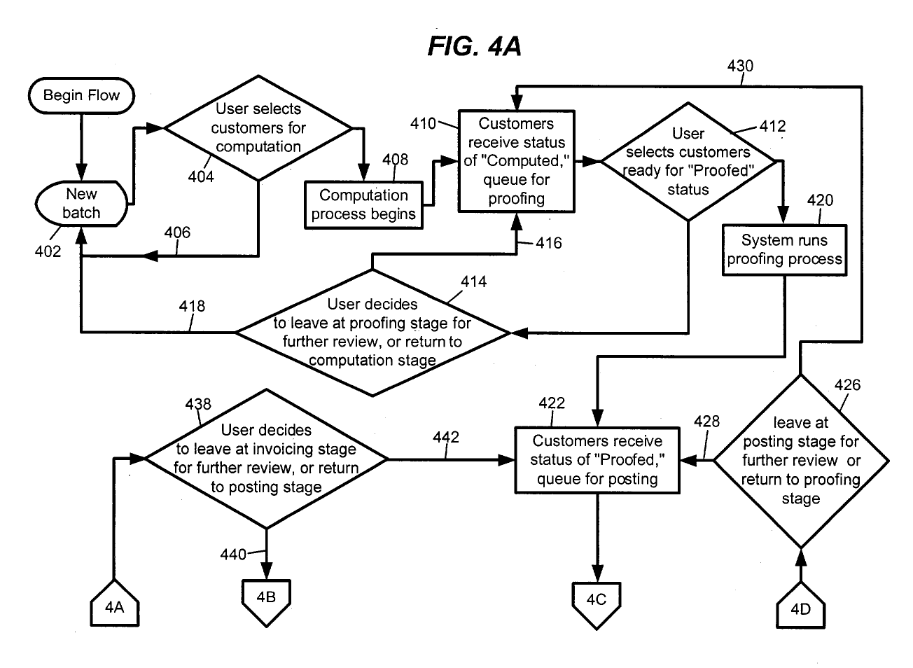

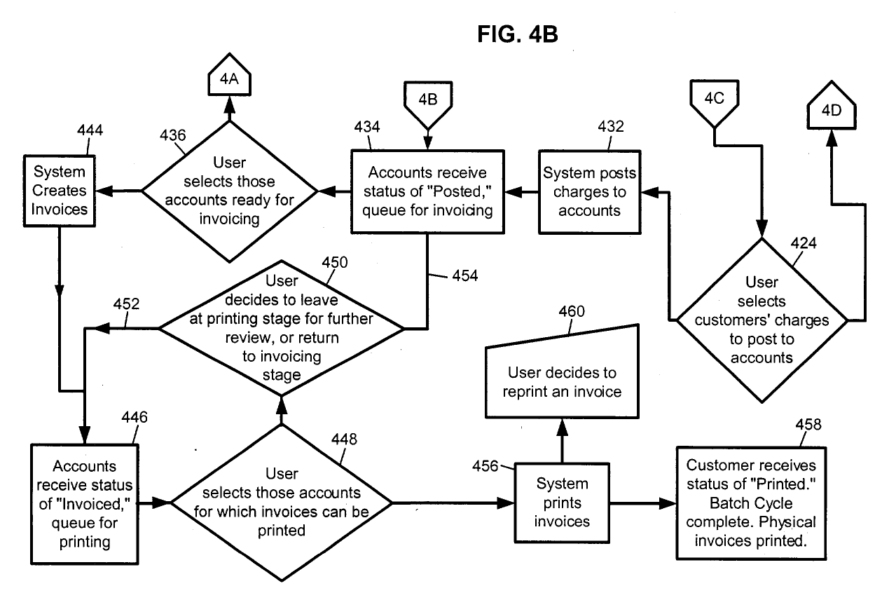

According to an alternate implementation the batch 302 is divided into sub-processes, each of which is associated with a status. Block 108 on FIG. 1 shows various statuses that may be attached to these sub-processes. These sub-processes will be explained in more detail hereinafter in FIGS. 4-10. An exemplary implementation shown in FIG. 3 shows five basic sub-processes, namely, computation, proofing, posting, invoicing and printing. However, an alternate implementation of the system may have more than five sub-processes. As the system processes each sub-process, it assigns a status to the customers affected in that batch. All of the customers with a given status are considered a sub-batch.

Batch 302 may also be further divided into discrete units. In the exemplary implementation shown in FIG. 3, division of the batch into discrete units occurs on two levels. On a most basic level, batch 302 is subdivided into individual customers 306. These customers 306 are then grouped into accounts 308. For example, an account may represent a single billing address to which an invoice is sent. The structure of the grouping from customer level to account level could be such that there is a one-to-one relationship between a customer and an account. For example, in the health insurance industry this basic model may work where individuals are billed separately for their own coverage. In an alternate implementation, multiple customers may be associated with a single account. For example, in the health insurance industry this basic model may work where employers are billed for the coverage of their workers.

During the billing process, at certain stages in the process, discrete units may refer to individual customers, while at other stages, discrete units may refer to accounts. In one exemplary implementation, the system allows users to move individual customers through the computation and proofing sub-batches, but it does not allow the movement of units smaller than an account from the posting stage forward. This is because, beginning with the posting stage, records related to the billing process are stored as part of the account record in the system. Since changes in the sub-process of posting and in the sub-processes after posting affect the account record directly, movement of discrete units is restricted to the account level during these sub-processes. However, during a particular run of the billing process, if an individual customer 306 is held back during the computation stage, the remainder of that customer's account 308 can move through the rest of the sub-processes without it. Information for the individual customer 306 may be added to the account 308 at a later time.

FIGS. 4A and 4B (hereinafter referred to as FIG. 4) illustrate a flow chart of an exemplary implementation of sub-processes used for batch processing. In particular, FIG. 4 illustrates an exemplary workflow through various stages and statuses in the system. It is possible that an entire batch may progress through this flow in a linear manner from start to finish. Alternatively, it is also possible that pieces of a batch might be moved ahead or backwards of the rest of the batch. FIG. 4 provides for a number of possible paths for a batch or its component through the system. For illustration purposes, FIG. 4 uses an employer group model of accounts for customers, however, the same workflow can also be implemented for a different type of group model.

At block 402, as processing for a new batch begins, each of the customers within that batch has a status of “New.” At block 404, a user begins the invoice computation process. Here the user determines which customers are to be deferred for the time being. In one implementation, the user is allowed to run this stage of the billing process automatically at a certain time in each billing period. Customers that are not selected retain the status of “New” as per 406, and they are computed at some point in future at the user's request. Since generally a few discrepancies are found in a batch before the billable amounts are calculated, a company may choose to automatically run this stage without prior user review, thus automating 404 and 406.

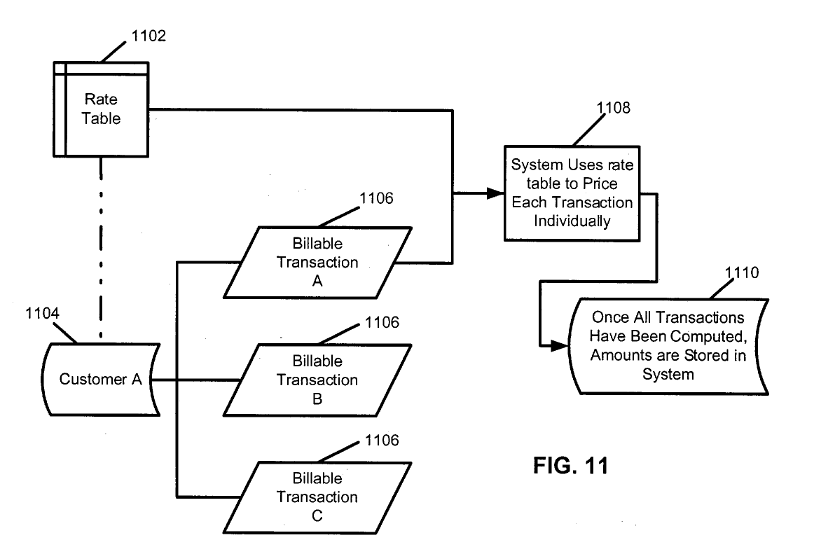

For those customers that were not deferred for future computation as per 406, the system begins the computation process at 408. The computation process is described in more detail hereinafter in FIG. 5 and FIG. 11. At block 410, those customers for whom the system has computed the invoice amounts, receive a status of “Computed.” Customers with the status of “Computed” are ready for proofing. At 412, the user verifies whether an individual customer's computed amount is correct or not. At 412 the user may decide that the computed amount is correct and mark the computation as verified, or the user may leave the customer unverified. If the user determines that at 412, the computed amount for a customer can not be verified, at 414 the user can either leave the customer marked as “Computed” or return its status to “New.” Subsequently, at 414, the user may leave a customer in the “Computed” sub-batch with a status of “Computed” if the user thinks that more review is necessary 416. In this case, the user can then research any perceived discrepancy, and move the customer to a status of “Proofed” at any later time. Alternatively, if the user changes the status of the customer at 414 to “New,” in which case the customer is transferred back into the “New” sub-batch 418 and subsequently resubmitted to the system for computing at 408.

The batch or the customers in a given batch that have been selected for proofing at 412 are submitted to the system for proofing at stage 420, that assigns the selected customers a status of “Proofed.” If in a given run of the billing process, the user does not want to verify any individual customer's computed amount, he or she may leave the entire batch selected on the interface and then prompt the system to assign them the status of “Proofed.” Customers with the status of “Proofed” are ready for the posting stage 422. The posting stage 422 is explained in more detail in FIG. 7 hereinafter.

Once computed amounts are posted to accounts, the user may choose to move individual accounts forward or back within the batch process at next stage 424. At all subsequent stages in the billing process, discrete units are defined as accounts, rather than individual customers. If the user decided that for any reason, that the computed amounts should not be posted to a particular account, at 426 he or she may allow that account to remain in the “Proofed” sub-batch for further investigation 428, or the user may return the account to the “Computed” sub-batch 430. An account returned to the “Proofed” sub-batch 428 may remain in that sub-batch for further review, or the user may select to run it through the posting process 432 at any time. Similarly, an account returned to the “Computed” sub-batch 430 may remain in that sub-batch for further review, or the user may select to run it through the proofing process 420 at any time. Please note that an account or an individual customer within an account may be returned to the “New” sub-batch from the “Computed” sub-batch.

At 424, a vast majority of accounts will most likely be ready for posting.

When the user selects such accounts to be posted through the interface 102 and prompts the system for posting, computed amounts for each selected account is added to that account's record in the system at 432 through the posting process. At 434, the system gives each of the posted account a status of “Posted.” The accounts in the posted sub-batch are ready for the invoicing stage. At 436, the user selects accounts for which he or she wants the system to create an invoice for. If the user determines that for any reason an invoice, should not be created for a particular account, at 438 the user can select such account to remain either in the “Posted” sub-batch 440 or the user can return such account to the “Proofed” sub-batch 442. At 440, the user can allow the accounts not selected for invoicing at stage 436 to remain in the “Posted” sub-batch and select to run the invoicing process on them at some time in the future. Alternatively, the user may choose to return 442 the accounts not selected for invoicing at stage 436 to the “Proofed” sub-batch. The user can rerun the posting stage on these accounts at any future time. Please not that an account or an individual customer within an account at this stage 442 may be returned to the “Computed” or “New” sub-batch from the “Proofed” sub-batch as well.

At 436, vast majority of accounts will most likely be ready for invoicing. For those customers associated with accounts selected for posting at 436, the system creates an electronic version of invoices at 444. At 444, the system does not create an invoice for any of the customers associated with any selected account that has been held back at an earlier stage in the billing process.

Once the system has created an electronic version of the invoice, at 446, such accounts are assigned the status of “Invoiced.” At this point the accounts are ready for the printing stage. At 448, the user selects accounts for which the user wants paper invoices to be printed. For any reason if the user determines that an invoice should not be printed for a particular account, at 450 the user can select such an account to remain in the invoiced sub-batch. At 452, the user can allow the accounts not selected for printing at stage 448 to remain in the “Invoiced” sub-batch and select to run the invoicing process on them at some time in the future. Alternatively, the user may choose to return at 454 the accounts not selected for invoicing at stage 448 to the “Posted” sub-batch. The user can rerun the invoicing stage on these accounts at any future time.

At 448, the vast majority of accounts will most likely be ready for printing. For those customers associated with accounts selected for printing at 448, the system either sends the invoices to a printer for printing or to a file for exporting. The user now has a physical copy, either on paper or on disk, of each invoice for the selected accounts, and the system assigns at 458 a status of “Printed” to each. Since the system stores an electronic version of each invoice, invoices for a particular account or batch can be reprinted without rerunning the rest of the process at any time 460.

FIG. 5 illustrates a flow chart of an exemplary implementation of a sub-process used for computation of invoices. Here computation refers to the process by which the system determines transaction prices and the sum of all transactions for a particular customer. In a given example using the health insurance industry providing insurance through an employer, this means that the system determines the premium amount for each insurance policy subscriber associated with a particular employer, and then computes the sum to be charged to that employer.

Separating the computation stage from other stages in the billing process allows a company with multiple locations to complete the computation stage at local offices, while other stages of the billing process are completed at a central location. Each company using this system can determine, based on its own workflow, how best to break-up the process across various locations. Alternately, a highly centralized company can complete all stages of the process at one central location. Since running each stage (computation, proofing, posting, invoicing, printing, etc.) requires only a click of a button on the user interface 102, the number of stages does not have a significant effect on the workload of the user.

A batch used in the billing process can be made up of multiple combinations for customers and accounts. In the example illustrated in FIG. 5, a batch 506 is comprised of two accounts 504, Account X and Account Y, and four customers 502, Customer A, Customer B, Customer C, and Customer D. During this process, discrete units of the batch 506 are moved from the “New” sub-batch into the “Computed” sub-batch. At the stage 508 if the user viewed the batch 506 through the user centralized work-queue 108, it will show all four customers in two accounts with a status of “New.” At 510, the user determines which customers are ready for computation. In most cases, the user simply initiates the computation process for the entire batch. However, in some cases, where the user knows that an individual customer is not ready for computation, the user can select to defer computing for that customer until further investigation.

Please note that this stage of the process 510 may also be triggered automatically by the system. Generally, review is not necessary at this stage, so a company may chose to have this stage of the process 510 run automatically at a given time each billing period.

At 512, suppose that the user has determined that Customer B cannot be computed at this time. Accordingly, Customer B retains the status of “New” and it will not be computed at this time 514. At 516 the system computes invoice amounts for Customers A, C and D.

At 518 when the user views the batch 506, centralized work queue 108 displays Customer B, associated with Account X, in the “New” sub-batch. While the same work queue 108 displays Customer A associated with Account X, and Customers C and D associated with Account Y, in the “Computed” sub-batch.

The centralized work queue 108 ensures, at this stage as well as the others in the process, that as pieces of a batch move through the batch process they are not lost. The statuses assigned to various components would ensure that at each stage, a user would be able to tell using the interface 102, where in the billing process a particular piece is. This means that there is no need to track discrepancies manually outside of the system.

As shown by 520, at any point in the billing process, the user can prompt the computation process for Customer B. When prompted, Customer B progresses through the computation process just as the remainder of the Batch 1 B did earlier. Customer B remains a piece of the same Batch 1, and can rejoin the rest of the pieces of Batch 1 for normal processing at any point. Thus, removing a discrete unit from the rest of the batch is not permanent, the way various ad hoc processes of previous solutions for such a problem required.

At 522, for all discrete units that have completed the computation stage, the system is ready to begin the proofing stage. As can be seen, the next stage can begin even if all of the customers have not completed the computation stage.

524 shows that customers can be returned to the “New” sub-batch for re-computation from subsequent stages, if necessary. This ability to move discrete units backward through the process eliminates the need to rerun an entire batch when an error is found in a discrete unit within a batch.

FIG. 6 illustrates a flow chart of an exemplary implementation of a sub-process used for proofing of invoices. In the exemplary implementation, the proofing stage refers to the point at which the user can scan the billable amounts that the system has calculated for each customer, and give a final seal of approval before these amounts are posted to each affected account in the system. This stage ensures that the computed amounts are checked for discrepancies before they are applied to a given account. In the example illustrated in FIG. 6, a batch 606 is comprised of two accounts 604, Account X and Account Y, and four customers 602, Customer A, Customer B, Customer C, and Customer D. During this stage in the process, discrete units of the batch are moved from the “Computed” sub-batch into the “Proofed” sub-batch.

At the stage 608 if the user viewed the batch 606 through the centralized work-queue 108, it will show all four customers in two accounts with a status of “Computed.” At 610, the user determines which customers are ready to receive a status of “Proofed.” In most cases, the user simply initiates the proofing process for the entire batch. However, in some cases, where the user knows that an individual customer is not ready to receive a status of “Proofed,” the user can select to defer proofing for that customer until further investigation. Additionally, if the user determines that a customer's bill had been computed incorrectly, that customer could be returned to the “New” sub-batch for re-computation.

At 612, suppose that the user has determined that Customer A has been computed incorrectly and that Customer B required more research before the amounts can be verified. Accordingly, at 614, Customer A is returned to the point in the process represented by 524 of FIG. 5. Customer A receives the status of “New.” Computation process can be rerun at any time in the future on Customer A. At stage 616 Customer B remains in the work queue with the status of “Computed.” Customer B is not proofed at this time, but the proofing process can be initiated for Customer B at any time. At stage 618, the system runs the proofing process for Customers C and D, assigning a status of “Proofed” to these customers.

If a user views batch 606 at stage 620, the centralized work queue 108 will display Customer A associated with Account X in the “New” sub-batch. The same work queue 108 will display Customer B associated with Account X in the “Computed” sub-batch and Customers C and D associated with Account Y in the “Proofed” sub-batch. Stage 622 shows that at any point in the billing process, the user can prompt the proofing process for Customer B. When prompted for proofing, Customer B will progress through the proofing process just as the remainder of batch 606 did earlier. Customer B remains a piece of the same batch 606, and can rejoin the rest of the batch for normal processing at any point. At stage 624, for all discrete units of batch 606 that have completed the proofing stage, the system is ready to begin the posting stage. The posting stage can begin even if all of the customers in the batch have not completed the proofing stage. Stage 626 shows that customers can be returned to the proofing stage of the billing process, from any subsequent stages. Customers returned to a stage in this way are processed just as other customers are processed at the proofing stage.

FIG. 7 illustrates a flow chart of an exemplary implementation of a sub-process used for posting of invoices. In the exemplary implementation, the posting stage refers to the point at which the proofed amounts are posted to the associated account for each customer.

Beginning with the posting stage, the smallest discrete unit that can be deferred or moved backward through the process is an account. This is because actions taken from this stage on are reflected on the record of the account in the system. Please note that individual customers that have been deferred at earlier stages in the process can still be processed separately.

In the example illustrated in FIG. 7, a batch 706 is comprised of two accounts 704, Account X and Account Y, and four customers 702, Customer A, Customer B, Customer C, and Customer D. During this stage in the process, batches are moved from the “Proofed” sub-batch into the “Posted” sub-batch.

At the stage 708 if the user viewed the batch 706 through the user centralized work-queue 108, it will show all four customers in two accounts with a status of “Proofed.” At 710, the user determines which accounts are ready for posting. In most cases, the user simply initiates the posting process for the entire batch. However, in some cases, where the user knows that an individual customer is not ready for posting, the user can select to defer posting for that customer until further investigation. Additionally, if the user determined that a customer's bill had been proofed incorrectly, that customer could be returned to the “Computed” sub-batch for reproofing. Please note that since a customer can be returned to the “New” sub-batch from the posting stage, it is possible to back a given customer through the entire process and begin the process again if necessary.

At 712, assume that the user determines that one account, Account Y, required more research before the amount can be posted. If the user determines at 714 that rerunning the proofing stage is necessary, he or she can return the account to the “Computed” sub-batch. The proofing process can then be rerun for this customer at any time, after which the posting process can be initiated. As per 716, account Y remains in the work queue in the “Proofed” sub-batch. Account Y is not posted at this time, but the posting process can be initiated for it at any time. At 718, the system runs the posting process for Account X, assigning a status of “Posted” to this account.

If a user views batch 706 at stage 720, the centralized work queue 108 will display Account Y, associated with two customers, in the “Proofed” sub-batch and Account X, associated with two customers, in the “Posted” sub-batch. As shown by 722, at any point in the process, the user can prompt the system to initiate posting process for Account Y. Account Y will progress through the posting process just as the remainder of batch 706 did earlier. It will remain a piece of the same batch, and can rejoin the rest of the batch 706 for normal processing at any point. For all accounts that have completed the posting stage, at 724 the system will be ready to begin the invoicing stage. The invoicing stage can begin for a batch even if all of the customers/accounts in the batch have not completed the posting stage. Customers can be returned to the stage of invoicing process for reposting from later stages of the billing process.

FIG. 8 illustrates a flow chart of an exemplary implementation of a sub-process used for creation of invoices. In the exemplary implementation, the invoicing stage refers to the creation of an electronic version of each invoice for a batch. By separating the stage for creation of the invoice from the other stages, the system is able to maintain an electronic image of each invoice that is not affected by the other steps of the invoicing process. This electronic version can be stored in the system for future reference, eliminating the need to maintain a paper copy for a company's records. This is an important step toward the paperless office.

In the example illustrated in FIG. 8, batch 806 is comprised of two accounts 804, Account X and Account Y, and four customers 802, Customer A, Customer B, Customer C, and Customer D. During this stage in the process, batches are moved from the “Posted” sub-batch into the “Invoiced” sub-batch.

At the stage 808 if the user viewed the batch 806 through the user centralized work-queue 108, it will show all four customers in two accounts with a status of “Posted.” At 810, the user determines which accounts are ready for invoicing. In most cases, the user simply initiates the invoicing process for the entire batch. However, in some cases, where the user knows that an individual customer is not ready for invoicing, the user can select to defer invoicing for that customer until further investigation. Additionally, if the user determined that a customer's bill had been posted incorrectly, that customer could be returned to the “Proofed” sub-batch for re-posting. Please note that since a customer can be returned to the “Computed” sub-batch, and then to the “New” sub-batch, from the proofed sub-batch, it is possible to back a given customer through the entire process and begin the process again if necessary.

At 812, assume that the user determines that one account, Account Y, required more research before its invoice can be created. If the user determines at 814 that rerunning the proofing stage is necessary, he or she can return the account to the “proofed” sub-batch. The posting process can then be rerun for this customer at any time, after which the invoicing process can be initiated. As per 816 account Y remains in the work queue in the “Posted” sub-batch. Account Y is not invoiced at this time, but the invoicing process can be initiated for it at any time. At 818, the system runs the invoicing process for Account X, assigning a status of “Invoiced” to this account.

If a user views batch 806 at stage 820, the centralized work queue 108 will display Account Y, associated with two customers, in the “Posted” sub-batch and Account X, associated with two customers, in the “Invoiced” sub-batch. As shown by 822, at any point in the process, the user can prompt the system to initiate invoicing process for Account Y. Account Y will progress through the invoicing process just as the remainder of batch 806 did earlier. It will remain a piece of the same batch, and can rejoin the rest of the batch 806 for normal processing at any point. For all accounts that have completed the invoicing stage, at 824 the system will be ready to begin the printing stage. The printing stage can begin for a batch even if all of the customers/accounts in the batch have not completed the invoicing stage. Customers can be returned to the stage of invoicing process for re-invoicing from later stages of the billing process.

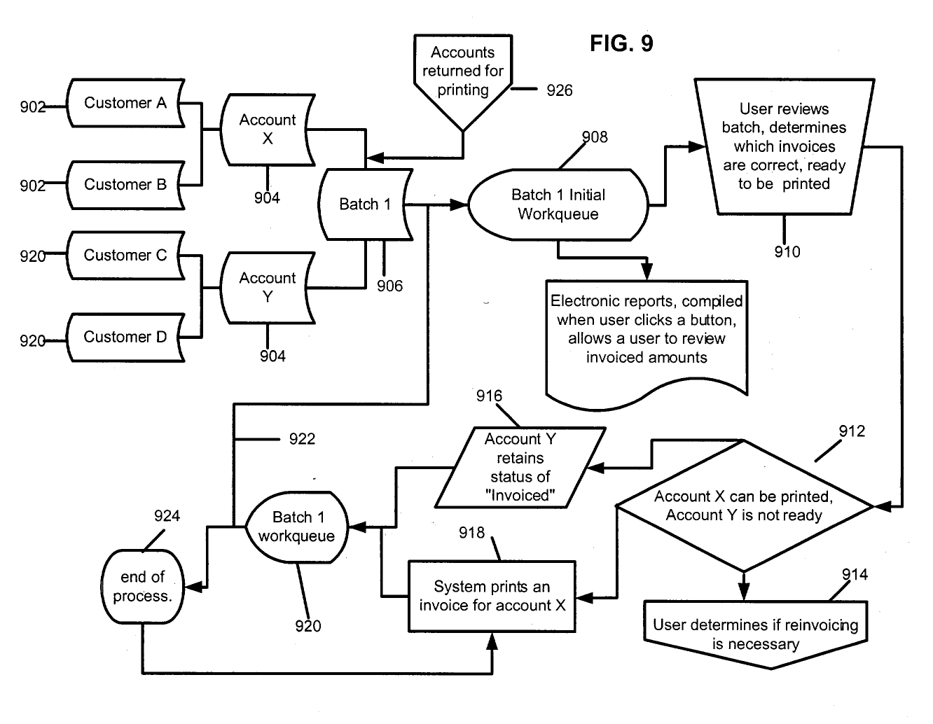

FIG. 9 illustrates a flow chart of an exemplary implementation of a sub-process used for printing of invoices. Printing of the invoices is the final stage of the billing process. At this stage, the invoices can be sent directly to a printer and printed, or they can be sent to a file. Companies that outsource their printing may use the second option.

By separating the printing process from the invoice generation process, the system allows for the reprinting of invoices without the having to regenerate those invoices. This also contributes to a paperless office, in that a physical copy of a previously generated invoice can be generated at any time. As such, there would be no need to keep a paper copy on file. Additionally, when problems such as printer errors or lost invoices occur, paper invoices can be quickly reprinted, without repeating any of the other steps in the billing process.

In the example illustrated in FIG. 9, a batch 906 is comprised of two accounts 904, Account X and Account Y, and four customers 902, Customer A, Customer B, Customer C, and Customer D. During this stage in the process, batches are moved from the “Invoiced” sub-batch into the “Printed” sub-batch.

At the stage 908 if the user viewed the batch 906 through the user centralized work-queue 108, it will show all four customers in two accounts with a status of “Invoiced.” At 810, the user determines which accounts are ready for printing. In most cases, the user simply initiates the printing process for the entire batch. However, in some cases, where the user knows that an individual customer is not ready for printing, the user can select to defer printing for that customer until further investigation. Additionally, if the user determined that a customer's bill had been invoiced incorrectly, the account for that customer can be returned to the “Posted” sub-batch for re-invoicing. Please note that since a customer can be returned to the “Proofed” sub-batch from the “Posted” sub-batch, and subsequently backed through to the “New” sub-batch, it is possible to back a given account or customer through the entire process and begin the process again, if necessary.

At 912, assume that the user determines that one account, Account Y, required more research before its invoice can be printed. If the user determines at 914 that rerunning the invoicing stage is necessary, he or she can return the account to the “Posted” sub-batch. The invoicing process can then be rerun for this customer at any time, after which the printing process can be initiated. As per 916 account Y remains in the work queue in the “Invoiced” sub-batch. Account Y is not printed at this time, but the printing process can be initiated for it at any time. At 918, the system runs the printing process for Account X, assigning a status of “Printed” to this account.

If a user views batch 906 at stage 920, the centralized work queue 108 will display Account Y, associated with two customers, in the “Invoiced” sub-batch and Account X, associated with two customers, in the “Printed” sub-batch. As shown by 922, at any point in the process, the user can prompt the system to initiate printing process for Account Y. Account Y will progress through the printing process just as the remainder of batch 906 did earlier. It will remain a piece of the same batch, and can rejoin the rest of the batch 906 for normal processing at any point. Once the invoices were printed for an account, the batch process is complete at 924. If an error is discovered after printing, the batch or discrete units thereof can be returned to an earlier stage in the process for reprocessing. As shown by 926, at any point after printing, a user can initiate reprinting for a single account or an entire batch without rerunning other batch processes. This minimizes the system resources used for reprinting and the amount of time a user has to devote to reprinting

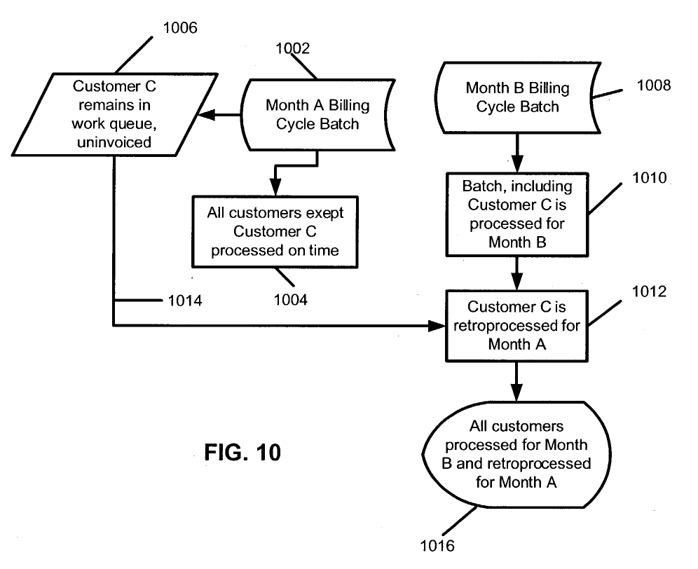

FIG. 10 illustrates a flow chart of an exemplary implementation of a sub-process used for automatic cancellation during retro-processing of batches. Retro-processing is an optional feature of the billing process. Enabling retro-processing allows a facility to add billed amounts for previous billing periods to a customer's invoice for the current period. The necessity for doing so occurs in cases where a user has been unable to complete an invoicing process for a customer before the following month's batch process begins. This capability will also cover cases where a customer's premium changes in the middle of a given billing period, after the invoice for that billing period has already been sent. An example of this for an employer-billed type account is when a new employee enrolls in an insurance program in the middle of a billing period. Using the option for retro-processing, an employer can be billed retroactively for the portion of the billing period that the employee had coverage. Thus, retro-processing feature allows a company to send one comprehensive invoice, rather than two in cases where processing for a given month takes longer than usual or when retro billing is necessary. This helps to cut down on the amount of paper used by a company, postage required to send out bills and the confusion that is created when a customer receives two bills from the same company at the same time.

To prevent billing a customer in this situation twice, a feature of the illustrated system includes an automatic cancellation feature. This feature causes the system to cancel processing for a previous billing period for a customer when the previous billing period's billed amount was computed into the current billing period for that customer.

The features of cancellation and retro-processing are illustrated in FIG. 10. Here 1002 represents a stage when Month A billing cycle batch is processed. At 1004, all customers in this batch are processed, except for Customer C. In most situations the majority of the batch will have the status of “Printed,” and the process will be complete for this part of the batch. At 1006 the Customer C sub-batch remains in the work queue for Month A with a status of “New.” At 1008, the system begins processing of the Month B billing cycle batch. When stage 1010 begins, the system determines that Customer C has not yet been computed for Month A. Subsequently, at stage 1012, the system computes the billable amount for Months A and B for Customer C, and includes both computed amounts in the Month B batch. At 1014, the system assigns a status of “Cancelled” to Customer C in the Month A work queue. Once this status is assigned, an invoice cannot be generated for this customer from the Month A work queue. When the batch processing for Month B completed, at stage 1016 all customers in the batch will have been invoiced for Month B. Additionally, Customer C's invoice will include charges for Month A.

FIG. 11 illustrates a flow chart of an exemplary implementation of a method for computation of an invoice. This flow chart helps to explain the computation stage of the illustrated billing process. 1102 represents an electronic rate table that lists the insurance premiums for various possible combinations of subscribers to that coverage. 1104 represents a customer that is associated to the rate table 1102. According to 1106, the system keeps track of employees associated with a given customer, where each employee is subject to insurance premium charges. 1108 illustrates that when the computation process is prompted during the billing process, the system uses the appropriate rate table to determine the insurance premiums for each of the employee for the given customer. Alternatively, the system can be configured to split the insurance premium so that the customer is responsible for a part of the premiums and the employee is responsible for part of the premium. For example, a customer can pay a certain percentage or a certain dollar amount of the insurance premiums. At stage 1110, the sum for insurance premiums for all employees associated with a customer is calculated and this sum, along with the individual amounts is recorded in the system. While the processing illustrated in FIG. 11 is one illustration of the computation process, it will be obvious to those of ordinary skill in the art that alternate method for the computation process using rate tables can also be used.

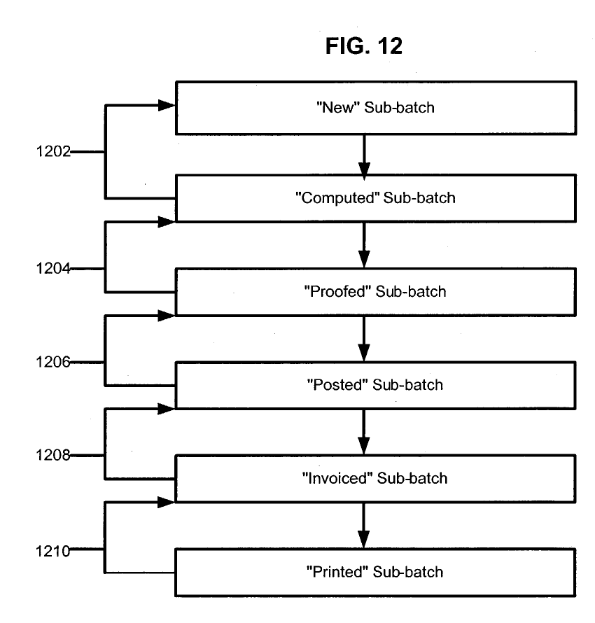

FIG. 12 illustrates a flow chart of an exemplary implementation of backward movement of batches through various stages of billing process. As shown in this figure, the system has the ability to move an entire batch or discrete units of a batch backward through the batch process. If an error in processing is discovered at any point in the process, a user can repeat only those stages that are necessary for only those units that have been affected. This saves time and system resources. For example, at 1202 a user can return individual customers or an entire batch to the “New” stage from the “Computed” stage for re-computation. Similarly, at 1204 a user can return individual customers or an entire batch to the “Computed” stage from the “Proofed” stage for re-proofing. Form there, the returned units can be re-proofed or returned to the “New” stage for re-computation. Similarly, at 1206 a user can return individual accounts or an entire batch to the “Proofed” stage from the “Posted” stage for re-posting. From there, the returned units can be reposted or returned to the “Computed” or “New” stage for reprocessing. At 1208, a user can return individual accounts or an entire batch to the “Posted” stage from the “Invoiced” stage for re-invoicing. From there, the returned units can be re-invoiced or returned to the “Proofed,” “Computed,” or “New” stage for reprocessing. At 1210, a user can return individual accounts or an entire batch- to the “Invoiced” stage from the “Printed” stage for re-printing. From there, the returned units can be re-printed or returned to the “Posted,” “Proofed,” “Computed,” or “New” stage for reprocessing.

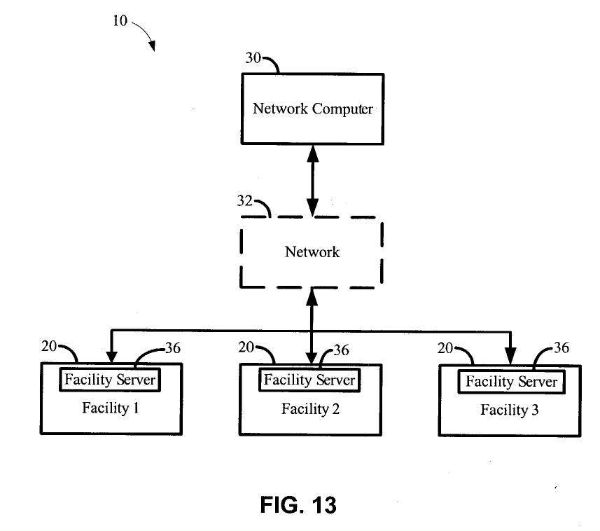

FIG. 13 illustrates a data network including a first group of healthcare facilities adapted to implement the system for batch processing invoices within a billing cycle. Specifically, FIG. 13 illustrates an embodiment of a data network 10 including a first-group of healthcare facilities 20 operatively coupled to a network computer 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

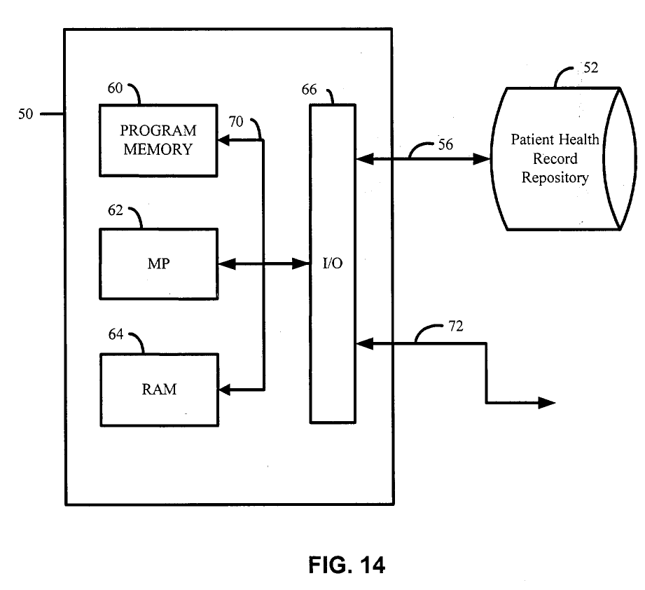

FIG. 14 is a schematic diagram of one possible embodiment of the-network computer 30 shown in FIG. 13. The network computer 30 may have a controller 50 that is operatively connected to a database 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

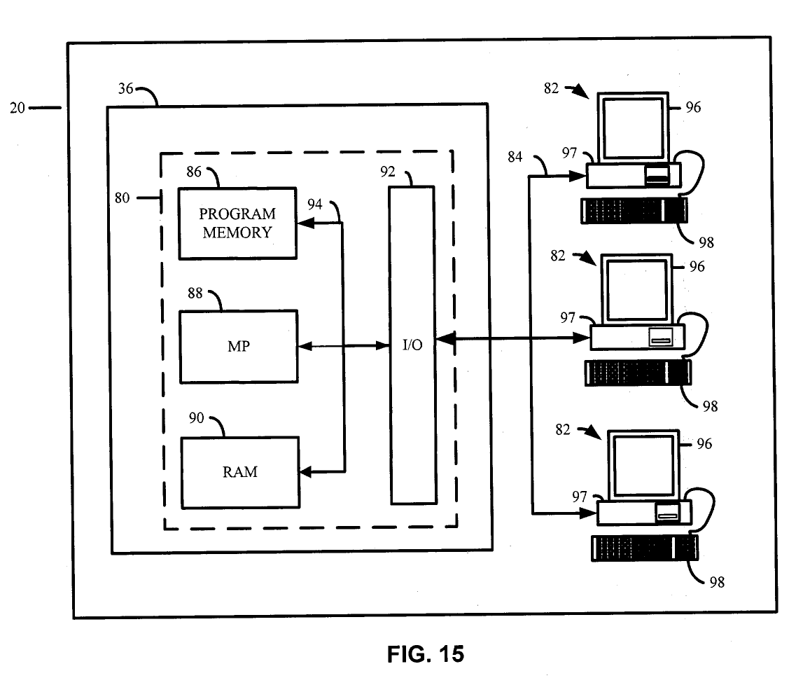

FIG. 15 is a schematic diagram of one possible embodiment of several components located in one or more of the healthcare facilities 20 from FIG. 13. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 15 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 13 via the network 32.

Similar to the controller 50 from FIG. 14, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

Although the system for batch processing invoices within a billing cycle, as described herein, is preferably implemented in software, it may be implemented in hardware, firmware, etc., and may be implemented by any other processor associated with the healthcare facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

In the foregoing specification the present patent has been described with reference to specific embodiments. However, one of ordinary skill in the art will appreciate that various modifications and changes can be made to these embodiments without departing from the scope of the present patent as set forth in the claims below. Accordingly, the specification and figures are to be regarded in an illustrative rather than in a restrictive sense, and all such modifications are intended to be included within the scope of the present patent.

What is claimed is:

1. A method of processing a first batch of records having a first number of records, comprising:
selecting a second number of records from the first batch;
performing a first operation on the second number of records;
assigning a first status to a first portion of the second number of records;
creating a second batch containing the first portion of the second number of records with the first status;
returning a second portion of the second number of records to the first batch;
selecting a third number of records from the second batch;
performing a second operation on the third number of records;
assigning a second status to a first portion of the third number of records;
creating a third batch containing the first portion of the third number of records with the second status; and
returning a second portion of the third number of records to the second batch.

2. The method of claim 1, wherein a first portion of the first number of records is in the first batch, a second portion of the first number of records is in the second batch, and a third portion of the first number of records is in the third batch.

3. The method of claim 2, wherein the first portion of the first number of records has the first status and the second portion of the first number of records has the second status.

4. The method of claim 3, wherein the first batch of records comprises at least one customer account.

5. The method of claim 4, wherein the customer account comprises at least one health insurance customer.

6. The method of claim 5, wherein:
the first operation is one of (1) computing of invoices; (2) proofing of invoices; (3) posting of invoices; and (4) invoicing of invoices;
the first status is status denoting one of (1) completion of the computing of invoices; (2) completion of the proofing of invoices; (3) completion of the posting of invoices; and (4) completion of the invoicing of invoices;
the second operation is one of (1) proofing of invoices; (2) posting of invoices; (3) invoicing of invoices; and (4) printing of invoices; and
the second status is a status denoting one of (1) completion of the proofing of invoices; (2) completion of the posting of invoices; (3) completion of the invoicing of invoices; and (4) completion of the printing of invoices.

7. The method of claim 1, further comprising displaying the status of the first number of records on a computer screen.

8. A method of processing a first batch of records having a first number of records, comprising:
performing a first operation on a first portion of the first batch;
assigning a first status to the first portion of the first batch;
creating a second batch containing the first portion of the first batch with a first status;
returning a first portion of the second batch to the first batch;
performing a second operation on a second portion of the second batch;
assigning a second status to the second portion of the second batch;
creating a third batch containing the second portion of the second batch with the second status; and
returning a first portion of the third batch to the second batch.

9. The method of claim 8, wherein a first portion of the first number of records is in the first batch, a second portion of the first number of records is in the second batch, and a third portion of the first number of records is in the third batch.

10. The method of claim 8, wherein a first portion of the first number of records has the first status and a second portion of the first number of records has the second status.

11. The method of claim 8, wherein the first batch of records comprises at least one customer account.

12. The method of claim 11, wherein the customer account comprises at least one health insurance customer.

13. The method of claim 8, wherein the first operation is a computing of invoices and the second operation is a proofing of invoices.

14. The method of clam 8, wherein the first operation is a proofing of invoices and the second operation is a posting of invoices.

15. The method of clam 8, wherein the first operation is a posting of invoices and the second operation is an invoicing of invoices.

16. The method of clam 8, wherein the first operation is an invoicing of a invoices and the second operation is a printing of invoices.

17. The method of claim 8, further comprising displaying status of the first number of records on a computer screen.

18. A method of processing a first batch of a first number of accounts, comprising:
selecting a second number of accounts from the first batch;
computing invoice amounts for the second number of accounts;
assigning a status denoting completion of computing to a first portion of the second number of accounts;
creating a second batch with the second number of accounts with the status denoting completion of computing;
returning a second portion of the second number of accounts to the first batch;
selecting a third number of accounts from the second batch;
proofing invoice amounts for the third number of accounts;
assigning a status denoting completion of proofing to a first portion of the third number of accounts;
creating a third batch with the third number of accounts with the status denoting completion of proofing;
returning a second portion of the third number of accounts to the second batch;
selecting a fourth number of accounts from the third batch;
posting invoice amounts for the fourth number of accounts;
assigning a status denoting completion of posting to a first portion of the fourth number of accounts;
creating a fourth batch with the fourth number of accounts with the status denoting completion of posting;
returning a second portion of the fourth number of accounts to the third batch;
selecting a fifth number of accounts from the fourth batch;
invoicing invoice amounts for the fifth number of accounts;
assigning a status denoting completion of invoicing to a first portion of the fifth number of accounts;
creating a fifth batch with the fifth number of accounts with the status denoting completion of invoicing;
returning a second portion of the fifth number of accounts to the fourth batch;
selecting a sixth number of accounts from the fifth batch;
printing invoices for the sixth number of accounts;
assigning a status denoting completion of printing to a first portion of the sixth number of accounts;
creating a sixth batch with the sixth number of accounts with the status denoting completion of printing; and
returning a second portion of the sixth number of accounts to the fifth batch.

19. A batch processing system for processing a first batch having a first number of records comprising:
first system adapted to perform a first operation on a first portion of the first batch;
second system adapted to assign a first status to the first portion of the first batch;
third system adapted to create a second batch containing the first portion of the first batch with the first status;
fourth system adapted to return a first portion of the second batch to the first batch;
fifth system adapted to perform a second operation on a second portion of the second batch;
sixth system adapted to assign a second status to the second portion of the second batch;
seventh system adapted to create a third batch containing the second portion of the second batch with the second status; and
eighth system adapted to return a first portion of the third batch to the second batch.

20. The system of claim 19, wherein the first operation is computing of invoices and the second operation is proofing of invoices.

21. For use with a batch processing system for processing a first batch having a first number of records, a computer program embodied on at least one computer readable medium comprising:
first software for performing a first operation on a first portion of the first batch;
second software for assigning a first status to the first portion of the first batch;
third software for creating a second batch containing the first portion of the first batch with a first status;
fourth software for returning a first portion of the second batch to the first batch;
fifth software for performing a second operation on all or a part of the second batch;
sixth software for assigning a second status to the second portion of the second batch;
seventh software for creating a third batch containing the second portion of the second batch with a second status; and
eighth software for returning a first portion of the third batch to the second batch.

22. A batch processing system for processing a first batch having a first number of records comprising:
first means for performing a first operation on a first portion of the first batch;
second means for assigning a first status to the first portion of the first batch;
third means for creating a second batch containing the first portion of the first batch with the first status;
fourth means for returning a first portion of the second batch to the first batch;
fifth means for performing a second operation on a second portion of the second batch;
sixth means for assigning a second status to the second portion of the second batch;
seventh means for creating a third batch containing the second portion of the second batch with the second status; and
eighth means for returning a first portion of the third batch to the second batch.
